(19) United States
(12) Patent Application Publication
(10) Pub. No.: US 2014/0258750 A1
(43) Pub. Date: Sep. 11, 2014

(54) CONTROL SYSTEM AND METHOD FOR SERVER

(71) Applicant: Hon Hai Precision Industry Co., Ltd., New Taipei (TW)

(72) Inventors: MENG-LIN TSAI, New Taipei (TW); HSIEN-CHUAN LIANG, Tu-Cheng (TW); CHIH-CHUNG SHIH, New Taipei (TW); SHOU-KUO HSU, Tu-Cheng (TW)

(73) Assignee: HON HAI PRECISION INDUSTRY CO., LTD., New Taipei (TW)

(21) Appl. No.: 14/198,637

(22) Filed: Mar. 6, 2014

(30) Foreign Application Priority Data
Mar. 6, 2013 (TW) 102107760

(51) Int. Cl. G06F 1/26; G06F 1/32

(52) U.S. Cl. CPC G06F 1/26; G06F 1/3296
USPC 713/320; 713/300

(57) ABSTRACT

A control system for a server includes a control chip, a switch module, a hardware power module, a software power module, a power chip, and a basement management controller (BMC) chip. The hardware power module and the software power module output first and second power signals, respectively. The control chip outputs corresponding state signals according to a control signal outputted by the BMC chip. The switch module selectively outputs the first or the second power signals to the power supply chip, to control the power supply chip to perform corresponding power operations.

### BACKGROUND

1. Technical Field

The present disclosure relates to a control system and method for a server.

2. Description of Related Art

In some servers, a micro-processor is used to power on or off of a server. However, if the micro-processor malfunctions, the server cannot be powered on/off normally.

Therefore, there is room for improvement in the art.

### BRIEF DESCRIPTION OF THE DRAWINGS

Many aspects of the present disclosure can be better understood with reference to the following drawing(s). The components in the drawing(s) are not necessarily drawn to scale, the emphasis instead being placed upon clearly illustrating the principles of the present disclosure. Moreover, in the drawing(s), like reference numerals designate corresponding parts throughout the several views.

FIG. 1 is a block diagram of an embodiment of a control system for a server of the present disclosure.

FIG. 2 is a schematic diagram of the control system of FIG. 1.

FIG. 3 is a flow chart of an embodiment of a control method for a server of the present disclosure.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

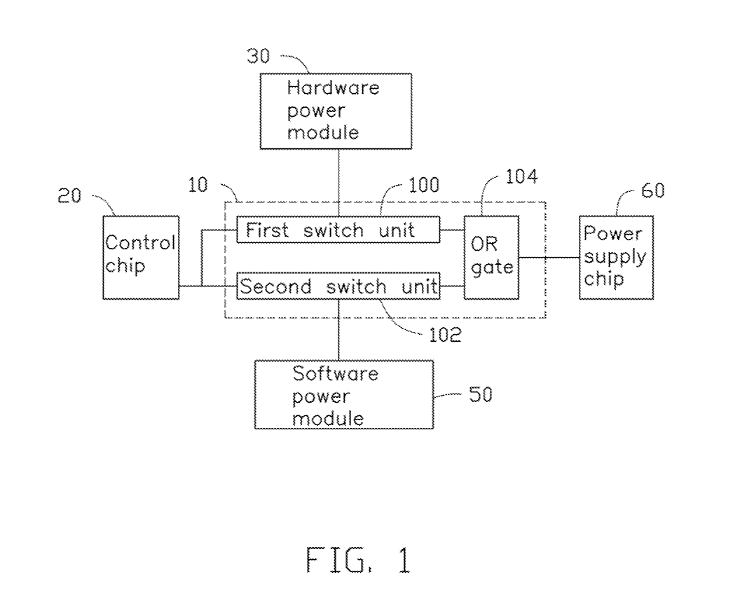

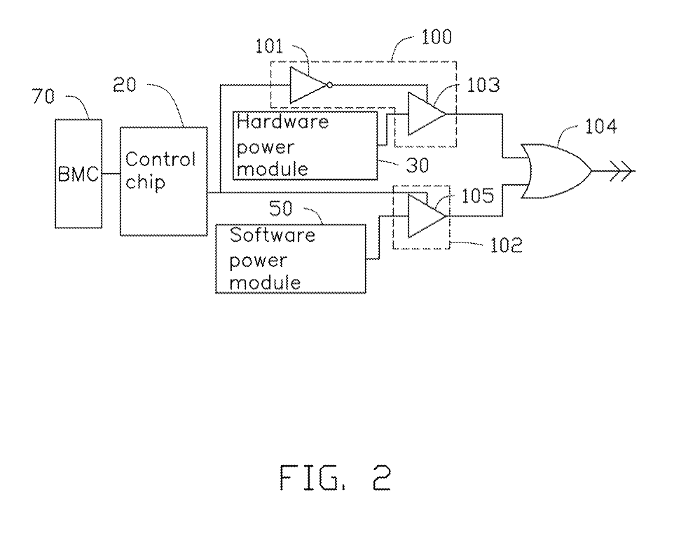

FIGS. 1 and 2 illustrate an embodiment of a control system of a server of the present disclosure. The control system comprises a control chip 20, a hardware power module 30, a software power module 50, a switch module 10, and a power supply chip 60, and a baseboard management controller (BMC) chip 70.

The hardware power module 30 outputs a first power signal, and the software power module 50 outputs a second power signal. In the embodiment, the first and second power signals control the server to perform a power on/off operation in different ways.

The control chip 20 receives control signals from the BMC chip 70, and obtains corresponding control commands from the control signals. The BMC chip 70 can be controlled by a user, remotely, and outputs different control signals according to operation of the user. For example, when the control chip 20 receives a first control signal comprising a first control command, the server is powered on/off in a first way. When the control chip 20 receives a second control signal comprising a second control command, the server is powered on/off in a second way. The control chip 20 further outputs a first state signal according to the first control command, and outputs a second state signal according to the second control command.

The switch module 10 comprises a first switch unit 100, a second switch unit 102, and an OR gate 104 coupled to the first and second switch units 100 and 102. The first switch unit 100 of the switch module 10 relays the first power signal outputted from the hardware power module 30 to the OR gate 104 upon receiving the first state signal. The second switch unit 102 of the switch module 10 relays the second power signal outputted from the software power module 50 to the OR gate 104 upon receiving the second state signal. In the embodiment, the first state signal is a high-voltage level signal, such as logic 1, and the second state signal is a low-voltage level signal, such as logic 0.

In the embodiment, the control chip 20 receives the control signals from the BMC chip 70 to perform the power on/off operations remotely.

The first switch unit 100 comprises an inverter 101 and a first tri-state buffer 103. An input terminal of the inverter 101 is coupled to the control chip 20 to receive the first or second state signals. An output terminal of the inverter 101 is coupled to an enable terminal of the first tri-state buffer 103. An input terminal of the first tri-state buffer 103 is coupled to the hardware power module 30 to receive the first power signal from the hardware power module 30. When the enable terminal of the first tri-state buffer 103 receives the second state signal through inverter 101, the output terminal of the first tri-state buffer 103 relays the first power signal outputted from the hardware power module 30. When the enable terminal of the first tri-state buffer 103 receives the first state signal through the inverter 101, the output terminal of the first tri-state buffer 103 does not relay the first power signal outputted from the hardware power module 30.

The second switch unit 102 comprises a second tri-state buffer 105. An enable terminal of the second tri-state buffer 105 is coupled to the control chip 20 to receive the first or second state signals. An input terminal of the second tri-state buffer 105 is coupled to the software power module 50 to receive the second power signal. When the enable terminal of the second tri-state buffer 105 receives the first state signal, an output terminal of the second tri-state buffer 105 relays the second power signal from the software power module 50. When the enable terminal of the second tri-state buffer 105 receives the second state signal, the output terminal of the second tri-state buffer 105 does not relay the second power signal from the software power module 50.

The OR gate 104 performs an OR operation on the first and second power signals received from the first and second switch units 100 and 102, respectively. The OR gate 104 further outputs an enable signal to the power supply chip 60 when the first power signal or the second power signal is received. The power supply chip 60 is coupled to the OR gate 104 to receive the enable signal. The power supply chip 60 outputs various voltages for the server when the enable signal from the OR gate 104 is received

In other embodiments, the first switch unit 100 and the second switch unit 102 output the first and second power signals to the power supply chip 60 directly, such that the OR gate 104 is omitted, and the power supply chip 60 outputs the various voltages when at least one of the first and second power signals is received. Accordingly, if the software power module 50 malfunctions, the server can be still powered on/off normally through the hardware power module 30.

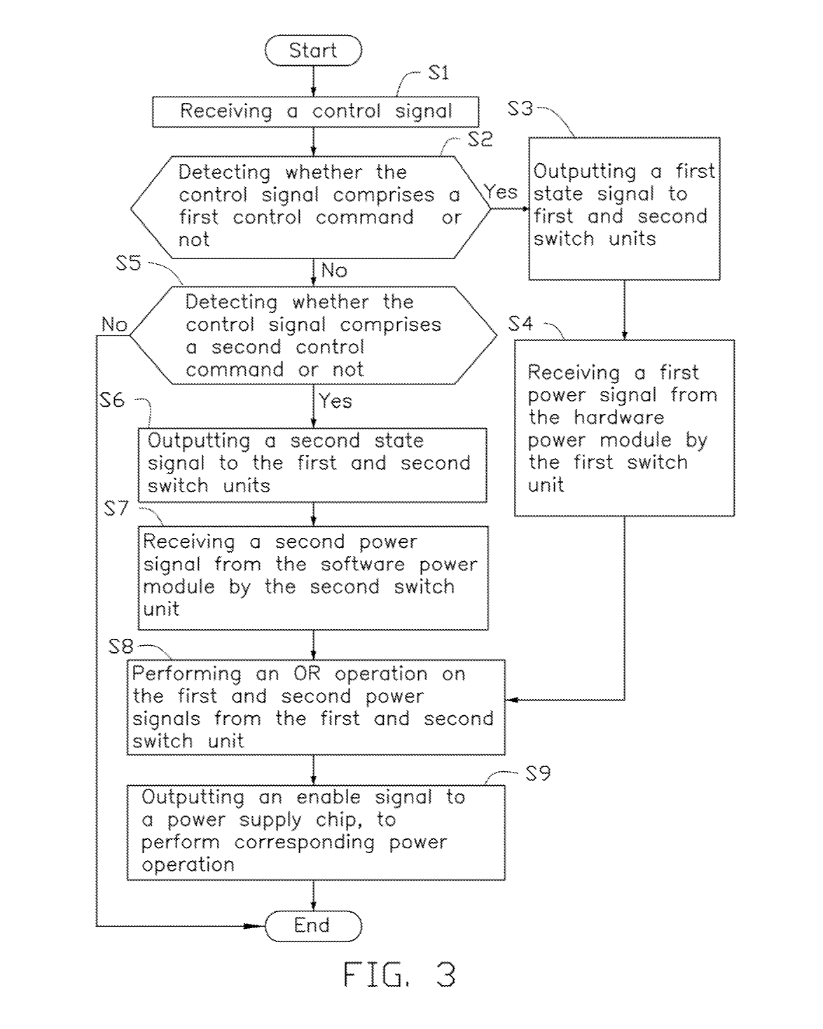

FIG. 3 shows a control method of the present disclosure. The control method comprises the following steps.

In step S1, the control chip 20 receives a control signal from the BMC chip 70.

In step S2, the control chip 20 detects whether the control signal from the BMC chip 70 comprises the first control command or not. If the control signal from the BMC chip 70 comprises the first control command, such as the first control signal, step S3 is implemented. If the control signal from the BMC chip 70 does not comprise the first command, step S5 is implemented.

In step S3, the control chip 20 outputs the first state signal to the first and second switch units 100 and 102.

In step S4, the first switch unit 100 outputs the first power signal from the hardware power module 30, and then step S8 is implemented.

In step S5, the control chip 20 detects whether the control signal from the BMC chip 70 comprises the second control command or not. If the control signal from the BMC chip 70 comprises the second control command, such as the second control signal, step S6 is implemented. Otherwise the process ends.

In step S6, the control chip 20 outputs the second state signal to the first and second switch units 100 and 102.

In step S7, the second switch unit 102 outputs the second power signal from the software power module 50.

In step S8, the OR gate 104 performs an OR operation on the first and second power signals.

In step S9, the OR gate 104 outputs the enable signal to the power supply chip 60, to activate the power supply chip 60 to perform corresponding power operation, such as powering on/off the server.

While the disclosure has been described by way of example and in terms of a preferred embodiment, it is to be understood that the disclosure is not limited thereto. On the contrary, it is intended to cover various modifications and similar arrangements as would be apparent to those skilled in the art. Therefore, the range of the appended claims should be accorded the broadest interpretation so as to encompass all such modifications and similar arrangements.

What is claimed is:

1. A control system, comprising:
a hardware power module outputting a first power signal;
a software power module outputting a second power signal;
a control chip outputting a first state signal or a second state signal according to control signals;
a switch module receiving the first power signal from the hardware power module and the second power signal from the software power module, comprising a first switch unit and a second switch unit; wherein when the switch module receives the first state signal, the first switch unit outputs the first power signal from the hardware power module, when the switch module receives the second state signal, the second switch unit outputs the second power signal from the software power module; and
a power supply chip performing power operation when at least one of the first power signal or the second power signal is received.

2. The control system of claim 1, wherein the switch module further comprises an OR gate, the OR gate is coupled to the first and second switch units, to receive the first or the second power signal, the OR gate performs an OR operation on the first and second power signals, and outputs an enable signal to the power supply chip, the power supply chip performs power operation when the enable signal is received by the power supply chip.

3. The control system of claim 2, wherein the control chip outputs a high-voltage level first state signal upon receiving a first control signal; the control chip outputs a low-voltage level second state signal upon receiving a second control signal.

4. The control system of claim 3, wherein the first switch unit comprises an inverter and a first tri-state buffer, an input terminal of the inverter is coupled to the control chip, to receive the first or the second state signal, an output terminal of the inverter is coupled to an enable terminal of the first tri-state buffer; an input terminal of the first tri-state buffer is coupled to the hardware power module, to receive the first power signal, an output terminal of the first tri-state buffer is coupled to the OR gate, wherein when the enable terminal of the first tri-state buffer is at a high voltage level, the first tri-state buffer outputs the first power signal to the OR gate.

5. The control system of claim 4, wherein the second switch unit comprises a second tri-state buffer, an enable terminal of the second tri-state buffer is coupled to the control chip, an input terminal of the second tri-state buffer is coupled to the software power module, to receive the second power signal, an output terminal of the second tri-state buffer is coupled to the OR gate;
wherein when the enable terminal of the second tri-state buffer is at a high voltage level, the second tri-state buffer outputs the second power signal to the OR gate.

6. The control system of claim 5, wherein the control signal is outputted by a baseboard management controller chip.

7. A control method, comprising steps of:
receiving a control signal;
detecting whether the control signal comprises a first control command or;
outputting a first state signal to a first and a second switch units in response to the control signal comprises the first control command;
outputting a first power signal from a hardware power module to a power supply chip by the first switch unit when the first switch unit receives the first state signal; and
performing corresponding power operation according to the first power signal by the power supply chip.

8. The control method of claim 7, further comprising:
detecting whether the control signal comprises a second control command, in response to the control signal does not comprise the first control command;
outputting a second state signal to the first and second switch units in response to the control signal comprises the second control command by the control chip;
outputting a second power signal from a software power module to the power supply chip by the second switch unit when the second switch unit receives the second state signal; and
performing power operation according to the second power signal by the power supply chip.

9. The control method of claim 8, further comprising:
performing an OR operation on the first and second power signals by an OR gate;
outputting an enable signal to the power supply chip in response to at least one of the first power signal or the second power signal being received by the OR gate; and
performing corresponding power operation according to the enable signal by the power supply chip.

10. The control method of claim 9, wherein the control signal is outputted by a baseboard management controller chip.
